(19) United States
(12) Patent Application Publication
(10) Pub. No.: US 2007/0098847 A1
(43) Pub. Date: May 3, 2007

(54) Food product containing lactic bacteria granules

(76) Inventor: Philippe Teissier, Massy (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/596,789

(22) PCT Filed: Dec. 20, 2004
(86) PCT No.: PCT/FR04/03309

§ 371 Date: Jun. 23, 2006

(30) Foreign Application Priority Data
Dec. 23, 2003 (FR) 0315243

(51) Int. Cl. A23C 9/12

(52) U.S. Cl. 426/61

(57) ABSTRACT

The invention relates to a liquid and aqueous food product containing dehydrated lactic bacteria granules and coated with a vegetable fat material.

### FIELD AND BACKGROUND OF THE INVENTION

The present invention relates to a liquid aqueous food product containing dehydrated lactic acid bacteria particles coated with vegetable fat.

Probiotics are live microorganisms which improve the intestinal microbial balance. Currently, various microorganisms, such as, for example, yeast, bacteria, and in particular bifidobacteria, lactobacilli, leuconostocs, pediococci and lactococci, can be used as probiotics, in particular in the agrofoods domain. In human food, these microorganisms or probiotics are mainly incorporated into fermented milk products such as yoghourts.

The microorganisms which are incorporated into food products undergo a certain number of attacks during the manufacture, storage and use thereof, which results in a decrease in their effectiveness which is most commonly associated with a considerable mortality rate.

Thus, the food products available on the market appear not to be able to provide their consumers with a sufficient number of probiotics to make it possible to obtain a sizeable health effect, due in particular to their poor resistance to storage or to the various stresses during their use in products or during their consumption (gastric stress, intestinal stress).

Various solutions aimed at protecting these microorganisms in order to ensure both their conservation in the final product and their effectiveness when the product is ingested by the consumer have already been proposed, including mixing them with fats or encapsulating them with fats.

Thus, European Patent Application EP 1 010 372 describes a cooked food product comprising both a probiotic and a prebiotic, i.e. a non-live indigestible ingredient which increases the activity of certain bacteria including probiotic bacteria in the colon. This food product is composed of an uncooked fatty part free of water and containing lyophilized live bacteria and of a cooked part consisting of prebiotics of indigestible fiber type. The fatty part containing the lyophilized bacteria consists of palm oil, coconut oil, vegetable butter such as cocoa butter or peanut butter, margarines, or hydrogenated or partially hydrogenated vegetable oils. The food product thus obtained is therefore of biscuit type and can be conserved for at least six months at ambient temperature.

International Application WO 99/09839 describes a paste-type composition which comprises an anhydrous fat or a fat substitute and a probiotic at a concentration ranging from 1×10⁷ to 5×10¹¹ CFU (colony forming units)/g of probiotic. The composition has a water activity (aw) of less than 0.7 and can be used for the manufacture of biscuit-type dry food products. This composition makes it possible to conserve, for several months at ambient temperature, a large and constant number of probiotics and also the properties thereof in the final product.

Moreover, International Application WO 01/68808 describes dehydrated live microorganism particles coated with a homogeneous layer of a hydrophobic substance chosen from fats, and also the manufacture thereof (granulation) and the application thereof in the manufacture of pharmaceutical, dietetic or food products. The granulation of live bacteria makes it possible to increase their resistance with respect to the physicochemical stresses that they are subjected to during their granulation and subsequent to their ingestion. The use of these particles in the agrofoods domain is briefly described and the food products which are cited as examples are cereals, confectionery products or powdered milk.

Finally, International Application WO 96/08261 describes a probiotic composition comprising one or more probiotic microorganisms which can be used in lyophilized form and a support comprising modified or unmodified resistant starch, or mixtures thereof, said support acting as a transporter and as a medium for the maintenance and growth of said microorganisms in the large intestine and other regions of the gastrointestinal tract. The lyophilized microorganisms are mixed with a preheated low melting point fat and then resistant starch is added to the dispersion obtained. Such a probiotic composition can be ingested directly or incorporated into food products and drinks, in particular yoghourts, juices, etc.

In addition to the choice of the substance(s) which can be used as protective materials, the coating methods must also overcome a certain number of difficulties including, in particular, the essential requirement of reconciling aggressive manufacturing processes with the use of fragile biological entities.

Furthermore, once coated, the microorganisms must be resistant to the storage conditions, conditions of use or conditions of implementation in the finished products, while at the same time being released in the host at the latest in the colon. For example, probiotics which have intestinal activity must admittedly be protected throughout their storage, but also during their path through the gastrointestinal tract (resistance to gastric acidity, for example), in order to optimize their effectiveness when they are used. Furthermore, during their use in the product and throughout their storage, the integrity of the granules must be preserved in order to ensure maintenance of the level of survival of the bacteria in the granules.

Thus, the various methods of protection and in particular of encapsulation described in the documents of the prior art mentioned above are particularly suitable for the incorporation of probiotics into dry food products or food products with a very low water activity.

Moreover, American Patent U.S. Pat. No. 6,447,823 describes a liquid yoghourt containing lactic acid bacteria encapsulated using a mixture of hardened oil and of starch, and optionally comprising a second layer consisting of gelatin and of pectin. Since the size of the capsules thus obtained is relatively large (1 to 3 mm), the manufacture of this type of yoghourt requires the use of a specific process for adding the capsules to the product. In fact, it is necessary to place the capsules at the bottom of the packaging bottle prior to the gradual filling of said bottle with the liquid yoghourt which must have a density very close to that of the capsules, so that the latter become distributed uniformly in the product. The production of such a product therefore imposes a considerable manufacturing constraint due to the size of the particles which makes it impossible to produce a dynamic mixture of the capsules.

Thus, the dispersion of granules that are too large appears to be difficult and said granules prove to be unstable in an aqueous environment, given their lipophilic nature. Thus, very aqueous food products do not constitute an ideal medium for ensuring the stability of lipophilic granules containing ferments.

Moreover, when it is desired to incorporate particles of bacteria coated with vegetable fats into a very liquid food product, it is essential that the size of the granules not be too large so as not to be perceptible in the mouth (feeling of grains of sand on the palate) in order to be able to provide a product that is acceptable from an organoleptic point of view. Finally, given the small amount of bacteria contained in each capsule, the amount of capsules to be dispersed in the liquid in order to manufacture a food product with a probiotic effect would be too great and would result in a product unacceptable from an organoleptic point of view being obtained.

Thus, in order to remedy all these major problems, the inventors have developed what is the subject of the invention.

They in particular gave themselves the aim of providing a liquid and very aqueous food product containing lactic acid bacteria coated using at least one plant fat, in which the survival of these probiotics is significantly increased in the finished product compared with the products currently available on the market.

### SUMMARY OF THE INVENTION

A subject of the present invention is therefore a liquid food product containing particles of dehydrated lactic acid bacteria coated with at least one vegetable fat that is solid at ambient temperature, characterized in that said coated bacteria are in the form of granules having an average size of between 95 and 300 μm containing lactic acid bacteria in an amount greater than or equal to 1×10¹⁰ CFU per gram of granules, in that said granules are free of starch, and in that said food product has a Ph of less than or equal to 4.5 and a water content by weight of at least 83%.

The inventors have in fact demonstrated that, despite the considerable acidity of the food product in accordance with the invention, the coating of the probiotic bacteria has the advantage of maintaining a high survival level of the microorganisms incorporated into the products and during its consumption in the host by protecting them against both the moisture and the oxygen in the product and increasing their resistance to the gastric and intestinal juices in the host while at the same time ensuring the release thereof at the latest in the colon. Furthermore, it is not necessary to incorporate starch as a nutritional support for the probiotic bacteria or as an additional support for improving the dispersion of the fat, unlike that which is described in the prior art and in particular in International Application WO 96/08261.

Finally, compared with the food product described in American U.S. Pat. No. 6,447,823, it is not absolutely necessary to adjust the texture of the food product according to the granules of probiotics to be incorporated, and it is possible to produce a dynamic mixture of the granules with the product, the size of the granules allowing ready dispersion thereof in the liquid, in order to directly package the final product.

Moreover, the inventors noticed that the use of granules whose size is greater than 300 μm would lead to problems of dispersion in the food product but also of perception of the granules during consumption of the finished product, which would be unacceptable from an organoleptic point of view. Furthermore, the use of particles containing a large number of dehydrated lactic acid bacteria while at the same time having a diameter of less than 95 μm would be difficult to implement from a technical point of view.

According to an advantageous embodiment of the present invention, the average size of the granules of lactic acid bacteria particles is less than approximately 200 μm, and even more advantageously, this size is approximately between 150 and 200 μm.

Among the liquid food products in accordance with the present invention, mention may in particular be made of fermented milk, beverages such as fruit juices, mixtures of milk and of fruit juices, such as, for example, the products sold under the trade mark Danao®, and vegetable juices such as, for example, soya juice and oat juice.

The lactic acid bacteria used in the food product according to the present invention are preferably chosen from lactobacilli and bifidobacteria, among which Lactobacillus casei, Lactobacillus plantarum, Bifidobacterium animalis and Bifidobacterium breve are most particularly preferred.

According to an advantageous embodiment of the present invention, the preferred lactic acid bacteria are chosen from the following strains: Lactobacillus plantarum deposited on Mar. 16, 1995, under the number DSM 9843, with the Deutsche Sammlung von Mikroorganismen und Zellkulturen GmbH, Brunswick, Germany; Lactobacillus casei deposited on Sep. 28, 1994, under the number I-1518, Bifidobacterium animalis deposited on May 20, 2000, under the number I-2494 and Bifidobacterium breve deposited on May 31, 1995, under the number I-2219, the latter three strains having been deposited with the CNCM (Collection Nationale de Culture de Microorganismes) [National Collection of Microorganism Cultures] held by the Institut Pasteur, 25 rue du Docteur Roux, in Paris.

As was disclosed above, one of the characteristics of the product in accordance with the invention is that the lactic acid bacteria used are dehydrated prior to them being granulated. The dehydration techniques which can be used to this effect for implementing the invention are entirely conventional and well known to those skilled in the art. Among such techniques, mention may in particular be made of dehydration on a fluidized air bed (FB) and lyophilization.

According to a particularly preferred embodiment of the invention, the lactic acid bacteria are dehydrated by lyophilization prior to them being granulated. In this case, the bacteria are preferably treated with a lyoprotectant prior to them being lyophilized. In this case, such lyoprotectants are in particular chosen from maltodextrin, sucrose, sodium ascorbate and powdered milk.

According to a particularly preferred embodiment of the invention, the bacteria are dehydrated directly after growth thereof in an appropriate culture medium.

The average size of the particles of dehydrated bacteria (before their granulation) is preferably approximately between 80 and 150 μm. In this regard, the size of the particles of dehydrated bacteria can optionally be adjusted, for example, by milling according to the conventional techniques well known to those skilled in the art.

The particles of dehydrated bacteria that can be used in the context of the invention preferably have, moreover, a water activity of less than 0.25, and even more preferably of between 0.03 and 0.2.

The granulation process used for coating the particles of dehydrated lactic acid bacteria with the vegetable fat must at the same time make it possible to prepare granules that effectively protect the bacteria to be coated without leading to degradation of said bacteria during the manufacture of the granules.

These two objectives are in particular achieved through the implementation of the production process as described in International Application WO 01/68808. The inventors have in fact discovered, surprisingly, that this granulation process can be used for the manufacture of granules of dehydrated lactic acid bacteria, which granules can then be used in order to prepare the food product in accordance with the present invention.

Among the vegetable fats that can be used for coating the particles of dehydrated bacteria according to the invention, mention may in particular be made of hydrogenated and nonhydrogenated, fractionated or unfractionated, esterified or nonesterified substances, such as palm stearic oil with a melting point (Mp)=35° C., palm oils with an Mp of 45° C. and 58° C., cocoa butter, peanut butter, palm kernel oil, hydrogenated coconut oil with an Mp=32° C., food waxes which are complex mixtures of esters of long chain fatty acids and fatty alcohols, such as carnauba wax (Mp=80-85° C.), microcrystalline wax of petroleum origin, fatty acids such as stearic acid and palmitic acid, and mixtures thereof.

According to a preferred embodiment of the present invention, and among the vegetable fats listed above, those which have a melting point above approximately 40° C. are particularly preferred.

Moreover, when said vegetable fats are used as a mixture, then said mixture preferably comprises more than 50% by weight of saturated fatty acids relative to the total weight of the fats that go to make up the composition of said mixture.

The concentration of dehydrated lactic acid bacteria in the granules is preferably greater than or equal to 1×10¹⁰ CFU per gram of granules, and a maximum of 5×10¹¹ CFU per gram of granules.

The water activity of the granules of dehydrated lactic acid bacteria particles used in the context of the present invention is preferably less than 0.4, and even more preferably between 0.1 and 0.2.

According to a preferred embodiment of the invention, the fat(s) represent(s) approximately from 40% to 75% by weight, and even more preferably approximately 60% by weight, relative to the total weight of the granules. Consequently, and by way of example, it may in particular be considered that a granule can consist of approximately 60% by weight of vegetable fats and of approximately 40% by weight of particles of dehydrated lactic acid bacteria.

In the liquid food product in accordance with the present invention, the concentration of coated lactic acid bacteria is preferably between 5×10⁶ and 5×10⁹ CFU per gram of finished product, and even more preferably this concentration is greater than or equal to 1×10⁷ CFU per gram of finished product.

According to a particularly preferred embodiment of the present invention, the liquid food product contains at least 90% of water. Among such products, and unlike the products that are described as yoghourts since they contain less than 90% of water, mention may in particular be made of semi-textured fermented products and beverages.

The amount of granules of dehydrated lactic acid bacteria particles in the liquid food product in accordance with the invention is preferably less than approximately 2% by weight relative to the total weight of finished food product, and even more preferably approximately between 0.01% and 1% by weight.

The consumption of a liquid food product in accordance with the present invention makes it possible to obtain a probiotic effect insofar as the amount of lactic acid bacteria ingested and which is finally present in the host is at least equal to 3×10⁶ CFU per gram of ingested food product.

Besides the above arrangements, the invention also comprises other arrangements which will emerge from the description which follows, which refers to two examples of preparation of a fermented milk food product, to an example of preparation of a food product of fruit juice type, to an example of preparation of a food product of vegetable juice type, to an example of preparation of a food product of fruit juice/vegetable juice type, and to a comparative study of the effect of Ph on the evolution of a standard milk having a Ph of greater than 4.5 and of a fermented milk having a Ph of less than 4.5, both containing granules of lactic acid bacteria, and also to the attached FIG. 1 in which the evolution in the amount of L. casei bacteria as a function of time can be observed in two milks having different pHs (medium 1: fermented milk with a Ph of less than 4.5 and medium 2: standard milk with a Ph of greater than 4.5).

### BRIEF DESCRIPTION OF THE DRAWING

FIG. 1 is a graph showing the evolution in the amount of L. casei bacteria as a function of time in two milks having different pHs.

### DETAILED DESCRIPTION

### EXAMPLE 1

### Preparation of a Fermented Milk Product in Accordance with the Invention

### 1) Preparation of Particles of Dehydrated Lactic Acid Bacteria

The L. casei strain I-1518 was cultured for 15 hours at a temperature of 37° C. on a Man Rogosa Sharpe (MRS) type culture medium, prior to it being lyophilized for 66 hours. The characteristics of the lyophilizate are as follows:
Water content: 2% (measured using a Sartorius® desiccator sold by the company Sartorius);
Aw: 0.1 measured with a Novasina® sold by the company Novasina;
Particle size: 80 microns;
Population: 1.7×10¹¹ CFU/g of lyophilized particles.

### 2) Preparation of the Granules of Dehydrated Lactic Acid Bacteria

The particles of lyophilized bacteria thus obtained above in step 1) are then coated on a fluidized bed in a 50/50 mixture of stearic acid and palmitic acid (% w/w) according to the process described in Example 2 of International Application WO 01/68808.

The degree of coating (% of fats relative to the total weight of the granules) was 60%.

The final characteristics of the granules thus produced were as follows:
Water content: 2%
Particle size: 200 microns
Population: 1×10¹¹ CFU/g of granules.

The population of lactic acid bacteria in the granules was stable for at least 3 months at ambient temperature in the dark and in the dry.

### 3) Preparation of the Fermented Milk Product

The granules obtained above in step 2) were introduced into a milk fermented beforehand with a mixture of Lactobacillus bulgaricus (5% by number) and of Streptococcus Thermophilus (95% by number), in a proportion of 0.1% by weight of granules per gram of milk. The fermented milk product thus obtained is then distributed into 200 ml pots.

The fermented milk product has a protein content of 2.5% by weight, which allows it to remain liquid at pH 4.2. The population of L. bulgaricus and of S. thermophilus is approximately 1×10⁹ CFU/ml of product. The concentration of L. casei in coated form was 10⁸ CFU/g of fermented milk product.

The amount of L. casei bacteria per ml of milk product as a function of time was determined according to a method of counting on suitable Oxgall culture medium. This study shows that the step consisting of granulation of the particles of lactic acid bacteria did not have any negative effect on the survival of the lactic acid bacteria in the finished product, for at least 35 days.

Similarly, the amounts of L. bulgaricus and of S. thermophilus present in the fermented milk product as a function of time were also determined in parallel. The results obtained (not represented) demonstrate that the presence of L. casei bacteria coated, in the form of granules, with fats, in the finished product, has no negative effect on the other populations of ferments present in uncoated form in this product.

The results of the organoleptic tests carried out with a panel of 10 tasters show, moreover, that this product is judged to be very similar (astringency, sweet taste, perception of particles, texture, unpleasant taste and acidity) to a comparative fermented milk product which is not part of the invention and contains the same amount of L. bulgaricus and S. thermophilus bacteria and also the same amount of L. casei, in uncoated form. Moreover, it is important to note that the fermented milk product in accordance with the invention had not developed any unpleasant taste by the end of the UBD (use-by date) of the product, which proves that the fats used for preparing the granules had not undergone any oxidation (had not turned rancid).

### EXAMPLE 2

### Preparation of a Food Product in Accordance with the Invention: Fermented Milk

1% by weight of L. casei granules manufactured according to Example 1 above was introduced into a stirred milk fermented beforehand for 10 hours at 37° C. with the strains L. bulgaricus, S. thermophilus and L. casei (in uncoated form).

The fermented milk was then distributed into 200 ml pots.

The population of L. bulgaricus, S. thermophilus and L. casei (in uncoated form) is greater than 1×10⁷ CFU/ml of product.

The measured amount of L. casei in the form of granules was 10⁹ CFU/g of finished product.

A study of the evolution of the amount of L. casei bacteria per ml of finished product as a function of time was then carried out. The results obtained (not represented) show that the granulation step does not decrease the survival of the lactic acid bacteria in the finished product for at least 35 days.

Furthermore, a similar study carried out on the populations of L. bulgaricus, S. thermophilus, L. casei bacteria (in uncoated form) demonstrates that the presence of coated L. casei bacteria has no negative effect on the other populations of ferments present in the finished product. As in Example 1, the results of the organoleptic tests carried out with a panel of 10 tasters show, moreover, that the product in accordance with the invention was judged to be very similar (same criteria as in Example 1 above) to the reference comparative product, i.e. product identical in all respects to the product in accordance with the invention except for the fact that it contained only bacteria in uncoated form. Finally, and just as in Example 1 above, the product in accordance with the invention had developed no unpleasant taste by the end of the UBD.

### EXAMPLE 3

### Preparation of a Food Product in Accordance with the Invention: Fruit Juice

L. casei granules manufactured according to Example 1 above are introduced in a proportion of 0.1% by weight per liter of orange juice at pH 3.5 (pure orange juice) so as to produce a fruit juice containing 10⁸ CFU of coated L. casei per gram of fruit juice.

The study of the evolution of the amount of L. casei per ml of finished product as a function of time shows that the granulation of the lactic acid bacteria does not decrease their survival in the finished product for at least 30 days.

The results of the organoleptic tests carried out with a panel of 10 tasters show, moreover, that the fruit juice in accordance with the invention is very similar (presence of a strange taste, sweet taste, texture and acidity) to a comparative standard fruit juice containing the same amount of lactic acid bacteria in uncoated form. Finally, the fruit juice in accordance with the invention had not developed any unpleasant taste by the end of the UBD, which indicates that the fats used for coating the bacteria do not turn rancid.

### EXAMPLE 4

### Preparation of a Food Product in Accordance with the Invention: Mixture of Fruit Juice and of Vegetable Juice

0.1% of L. casei granules as prepared above in Example 1 is introduced into a fermented liquid product composed of 89.9% of pure orange juice and of 10.1% of soya juice fermented with L. bulgaricus and S. thermophilus.

The concentration of particles of coated lactic acid bacteria was 10⁸ CFU/g in the finished product.

The study of the evolution of the amount of bacteria per ml of finished product as a function of time showed (results not represented) that the bacterial granulation step does not decrease the survival of said bacteria in the finished product for at least 30 days.

The results of the organoleptic tests carried out with a panel of 10 tasters showed, moreover, that the product was judged to be very similar (presence of an unpleasant taste, texture, perception of particles, acidity and astringency) to a standard comparative fermented juice containing the same amount of L. casei bacteria, in uncoated form, and that it does not develop any unpleasant taste by the end of the UBD.

Identical results were obtained by combining fermented oat juice or fermented milk with fruit juices.

### EXAMPLE 5

### Comparative Study of the Effect of pH: Introduction of Granules of Bacteria into a Standard Milk and into a Fermented Milk

Granules of L. casei lactic acid bacteria at 1×10¹¹ CFU/g of granules, as prepared in Example 1 above, were introduced into two media of different pH, i.e. a milk fermented beforehand with L. bulgaricus and S. thermophilus (medium 1) and a standard nonfermented milk (medium 2), in a proportion of 1% by weight.

The pH of medium 1 was 4.5 and that of medium 2 was 6.5.

Media 1 and 2 were then distributed into sterile 200 ml pots.

The amount of coated lactic acid bacteria was 10⁸ CFU/g in each pot.

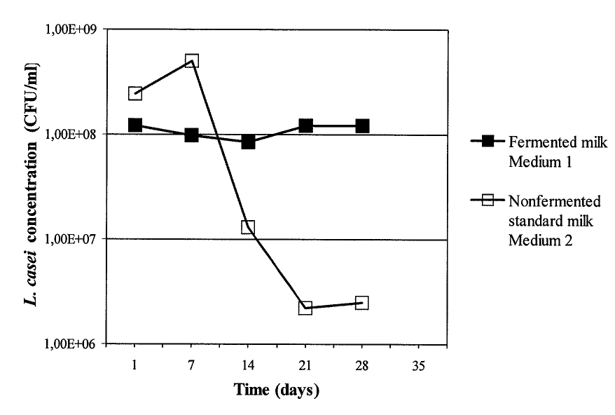

The study of the evolution of the amount of bacteria per ml of finished product as a function of time is represented in the attached FIG. 1, in which the concentration of L. casei expressed in CFU/ml of milk, for each of the two media (medium 1: solid squares, medium 2: empty squares), as a function of time in days, shows that the product corresponding to medium 2 evolves differently from that corresponding to medium 1. A very large and very rapid decrease in the amount of L. casei lactic acid bacteria is in particular noted in medium 2, whereas this amount remains constant in medium 1 in accordance with the invention.

Moreover, after storage for 12 days at a temperature of 12° C., the product corresponding to medium 2 begins to ferment and to swell due to the development of a heterogeneous flora in the milk.

On the other hand, no fermentation occurs in the product corresponding to medium 1 in accordance with the invention, i.e. having a pH of less than 4.5.

Moreover, the results of the organoleptic tests carried out with a panel of 10 tasters showed that the product corresponding to medium 1 is very similar (astringency, sweet taste, perception of particles, texture, unpleasant taste and acidity) to a standard comparative product based on fermented milk and containing the same amount of L. casei bacteria as in the product prepared with medium 1, but in uncoated form, and that it does not develop an unpleasant taste by the end of the UBD of the product.

On the other hand, the product corresponding to medium 2 was found to be inconsumable due to the development of a surface flora after 21 days that had led to swelling of the pot. Visual examination reveals a product with a large degree of phase separation and a totally unacceptable appearance.

Consequently, all these results show not only that pH conditions of less than 4.5 are not harmful to the conservation of the granules of lactic acid bacteria in a finished product, but that, on the contrary, these pH conditions are necessary for good conservation of the product up until the end of the UBD.

1. A liquid food product containing particles of dehydrated lactic acid bacteria coated with at least one vegetable fat that is solid at ambient temperature, wherein said coated bacteria are in the form of granules having an average size of between 95 and 300 μm containing lactic acid bacteria in an amount greater than or equal to 1×10¹⁰ CFU per gram of granules, in that said granules are free of starch, and in that said food product has a pH of less than or equal to 4.5 and a water content by weight of at least 83%.

2. The food product as claimed in claim 1, wherein the average size of the granules of lactic acid bacteria particles is less than 200 μm.

3. The food product as claimed in claim 1 wherein the average size of the granules of lactic acid bacteria particles is between 150 and 200 μm.

4. The food product as claimed in claim 1 wherein it is in the form of a fermented milk or of a beverage.

5. The food product as claimed in claim 4, wherein the beverage is a fruit juice, a mixture of milk and of fruit juice or a vegetable juice.

6. The food product as claimed in claim 1 wherein the lactic acid bacteria are chosen from lactobacilli and bifidobacteria.

7. The food product as claimed in claim 6, wherein the lactic acid bacteria are chosen from Lactobacillus casei, Lactobacillus plantarum, Bifidobacterium animalis and Bifidobacterium breve.

8. The food product as claimed in claim 7, wherein the lactic acid bacterium is a Lactobacillus casei I-1518.

9. A food product as claimed in claim 1 wherein the lactic acid bacteria are dehydrated by lyophilization prior to them being granulated.

10. The food product as claimed in claim 9, wherein the bacteria are treated with a lyoprotectant prior to them being lyophilized.

11. The food product as claimed in claim 1 wherein the particles of dehydrated bacteria have an average size of between 80 and 150 μm.

12. The food product as claimed in claim 1 wherein the particles of dehydrated bacteria have a water activity of less than 0.25.

13. The food product as claimed in claim 1 wherein the vegetable fats used for coating the particles of dehydrated bacteria are chosen from hydrogenated and nonhydrogenated, fractionated or unfractionated, esterified or nonesterified substances, food waxes, fatty acids, and mixtures thereof.

14. The food product as claimed in claim 13, wherein the vegetable fats are chosen from palm stearic oil with a melting point (Mp)=35° C., palm oils with an Mp of 45° C. and 58° C., cocoa butter, peanut butter, palm kernel oil, hydrogenated coconut oil with an Mp=32° C., carnauba wax with an Mp=80-85° C., microcrystalline wax of petroleum origin, stearic acid, palmitic acid, and mixtures thereof.

15. The food product as claimed in claim 14, wherein the vegetable fats used for coating the particles of dehydrated bacteria are chosen from those which have a melting point above 40° C.

16. The food product as claimed in claim 1 wherein the concentration of dehydrated lactic acid bacteria in the granules is greater than or equal to 1×10¹⁰ CFU per gram of granules, and a maximum of 5×10¹¹ CFU per gram of granules.

17. The food product as claimed in claim 1 wherein said granules have a water activity of less than 0.4.

18. The food product as claimed in claim 1 wherein the fat(s) represent(s) from 40% to 75% by weight relative to the total weight of the granules.

19. The food product as claimed in claim 1 wherein the concentration of coated lactic acid bacteria is between 5×10⁶ and 5×10⁹ CFU per gram of finished product.

20. The food product as claimed in claim 1 wherein the food product contains at least 90% of water.

21. The food product as claimed in claim 1 wherein the amount of granules of dehydrated lactic acid bacteria particles is less than 2% by weight relative to the total weight of finished product.

22. The food product as claimed in claim 21, wherein the amount of granules of dehydrated lactic acid bacteria particles is between 0.01% and 1% by weight relative to the total weight of finished product.
